(19) United States
(12) Patent Application Publication
(10) Pub. No.: US 2015/0055336 A1
(43) Pub. Date: Feb. 26, 2015

(54) PIXEL STRUCTURE AND DISPLAY USING THE SAME

(71) Applicant: Lextar Electronics Corporation, Hsinchu (TW)

(72) Inventors: Shih-Hsien Huang, Tainan City (TW); Shih-Hao Wang, Tainan City (TW); Po-Yuan Huang, Taichung City (TW)

(73) Assignee: Lextar Electronics Corporation, Hsinchu (TW)

(21) Appl. No.: 14/246,172

(22) Filed: Apr. 7, 2014

(30) Foreign Application Priority Data
Aug. 26, 2013 (TW) 102130466

(51) Int. Cl. F21K 99/00

(52) U.S. Cl. CPC F21K 9/54
USPC 362/231; 362/235

(57) ABSTRACT

A pixel structure comprising an N-side light emitting surface, several reflectors and several light emitting elements is provided. N is a nature number equal to or greater than 3. The light emitting surface has a first normal line. The reflectors surround peripherals of the light emitting surface. Each reflector, which correspondingly connects with a side of the light emitting surface, is connected to its adjoining reflectors and comprises a first reflecting portion and a second reflecting portion having a second normal line and a third normal line, respectively. The second and the first normal lines intercross to form an acute angle α, and the third and the first normal lines intercross to form an obtuse angle β. The lights emitted by the light emitting elements are reflected by the second reflecting portion of the reflectors so that the lights are directed towards the light emitting surface.

This application claims the benefit of Taiwan application Serial No. 102130466, filed Aug. 26, 2013. The subject matter of which is incorporated herein by reference.

### BACKGROUND OF THE INVENTION

1. Field of the Invention

The invention relates in general to a display, and more particularly to a pixel structure and a display using the same.

2. Description of the Related Art

Along with the continual advance in semiconductor technology, consumers demand displays with higher and higher display quality and expect that the displays can display image with high brightness, resolution and contrast, and more importantly, the displays can have the advantages of lightweight and low power consumption.

In an ordinary liquid crystal display, a pixel structure is composed of red sub-pixels, green sub-pixels and blue sub-pixels, and the colors of an image are formed by the RGB primary colors. However, conventional display uses light emitting diode array (LED array) as a backlight source of a backlight module, and cannot adjust the brightness of respective pixel structure or the proportion of light outputting for each sub-pixel. Therefore, the color saturation of the image is poor and the color rendering index (CRI) is low.

### SUMMARY OF THE INVENTION

The invention is directed to a pixel structure and a display using the same. The lights of different colors are mixed in respective pixel structures first and then the mixed lights are outputted via a light emitting surface so as to increase the color rendering index.

According to one embodiment of the present invention, a pixel structure is provided. The pixel structure comprises an N-side light emitting surface, a plurality of reflectors and a plurality of light emitting elements. N is a nature number equal to or greater than 3. The light emitting surface has a first normal line. The reflectors surround peripherals of the light emitting surface. Each reflector, which correspondingly connects with a side of the light emitting surface, is connected to its adjoining reflectors and comprises a first reflecting portion and a second reflecting portion connected to the first reflecting portion. The first reflecting portion and the second reflecting portion have a second normal line and a third normal line, respectively. The second normal line and the first normal line intercross to form an acute angle α. The third normal line and the first normal line intercross to form an obtuse angle β. The light emitting surface and the reflectors define a closed light reflecting space therein. The light emitting elements are disposed on the first reflecting portions in a direction facing towards the closed light reflecting space, respectively. Lights emitted by the light emitting elements are reflected by the second reflecting portions of the reflectors so that the lights are directed towards the light emitting surface.

According to another embodiment of the present invention, a display is provided. The display comprises a plurality of pixel structures adjoining to each other to form a pixel array. Each pixel structure comprises an N-side light emitting surface, a plurality of reflectors and a plurality of light emitting elements. N is a nature number equal to or greater than 3. The light emitting surface has a first normal line. The reflectors surround peripherals of the light emitting surface. Each reflector, which correspondingly connects with a side of the light emitting surface, is coupled to its adjoining reflectors and comprises a first reflecting portion and a second reflecting portion connected to the first reflecting portion. The first reflecting portion and the second reflecting portion have a second normal line and a third normal line, respectively. The second normal line and the first normal line intercross to form an acute angle α. The third normal line and the first normal line intercross to form an obtuse angle β. The light emitting surface and the reflectors define a closed light reflecting space therein. The light emitting elements are respectively disposed on the first reflecting portion in a direction facing towards the closed light reflecting space. Lights emitted by the light emitting elements are reflected by the second reflecting portions of the reflectors so that the lights are directed towards the light emitting surface.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view of a pixel structure according to an embodiment of the invention.

FIGS. 2A˜2C are 3D diagrams of different pixel structures according to an embodiment of the invention.

FIG. 3A is a schematic diagram of a light reflecting space within a pixel structure.

FIG. 3B is a cross-sectional view of two adjoining pixel structures.

FIGS. 4A˜4D are top views of different pixel structures.

FIGS. 5A˜5D are top views of different displays according to an embodiment of the invention.

### DETAILED DESCRIPTION OF THE INVENTION

According to a pixel structure and a display using the same disclosed in the embodiment of the invention, a single pixel structure is composed of an N-side light emitting surface, a plurality of light emitting elements and a plurality of reflectors. The display comprises a plurality of pixel structures adjoining to each other to form a pixel array for displaying an image. The light emitting elements are composed of red, green, and blue (RGB) light emitting diodes (LEDs) or composed of red, green, blue, and yellow (RGBY) LEDs. The quantity and arrangement of the light emitting elements of different colors can be adjusted so that the lights of different colors are mixed in respective pixel structure and then are outputted from the light emitting surface to increase color rendering index.

A number of embodiments are disclosed below for elaborating the invention. However. The embodiments of the invention are for detailed descriptions only, not for limiting the scope of protection of the invention.

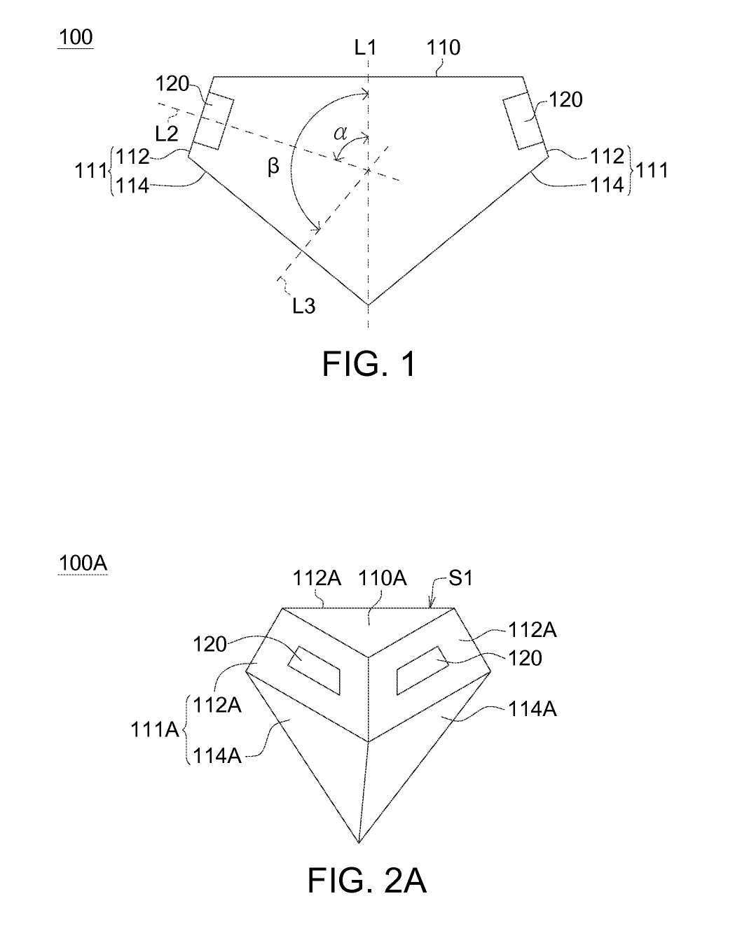

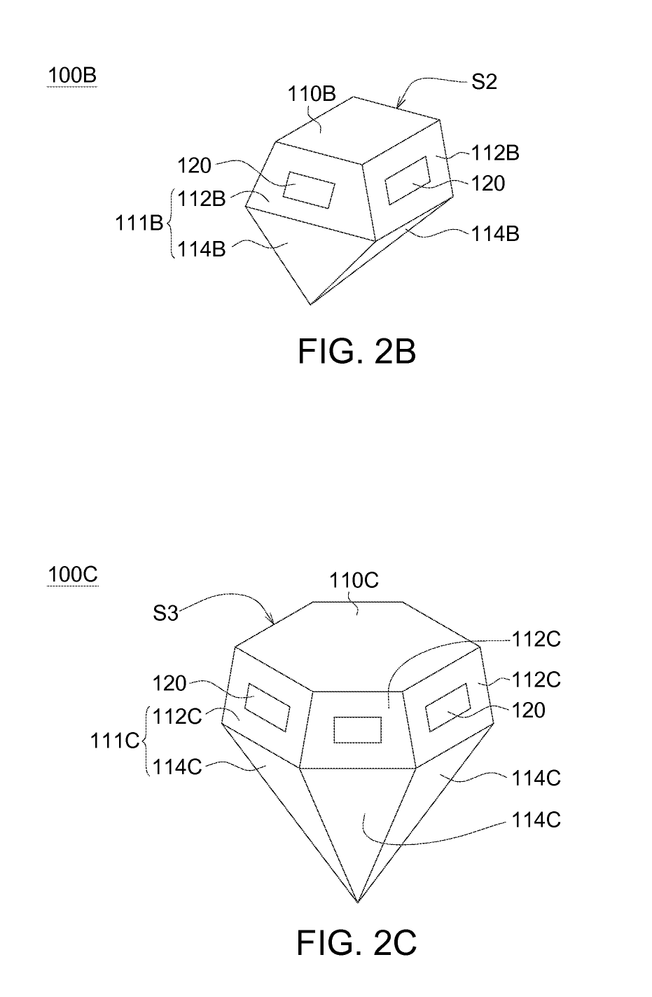

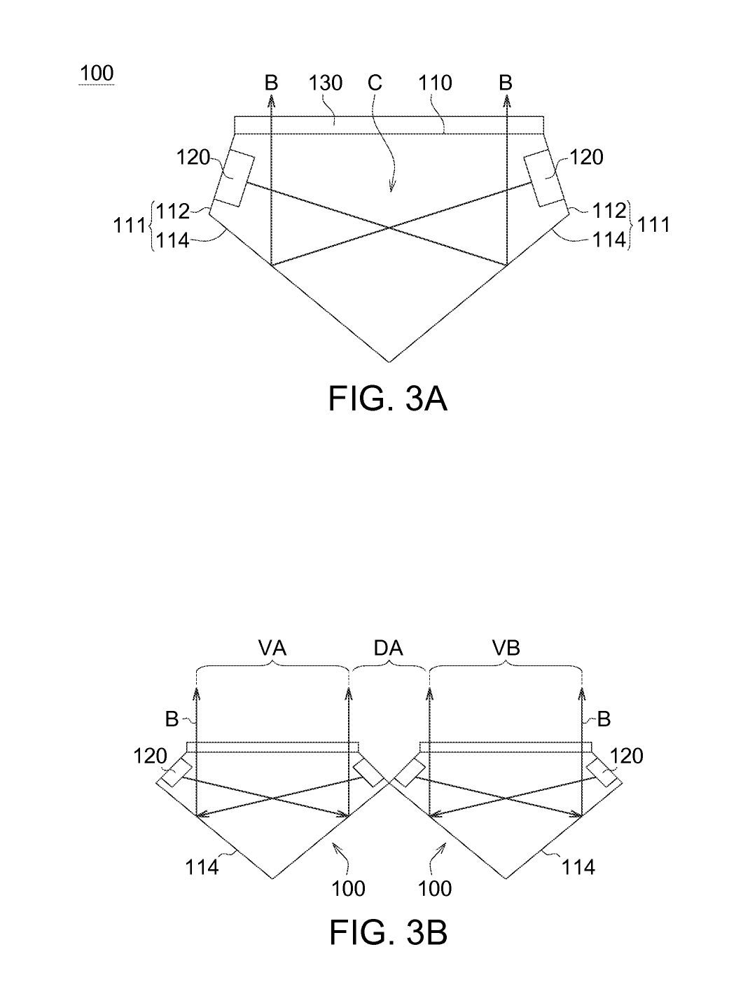

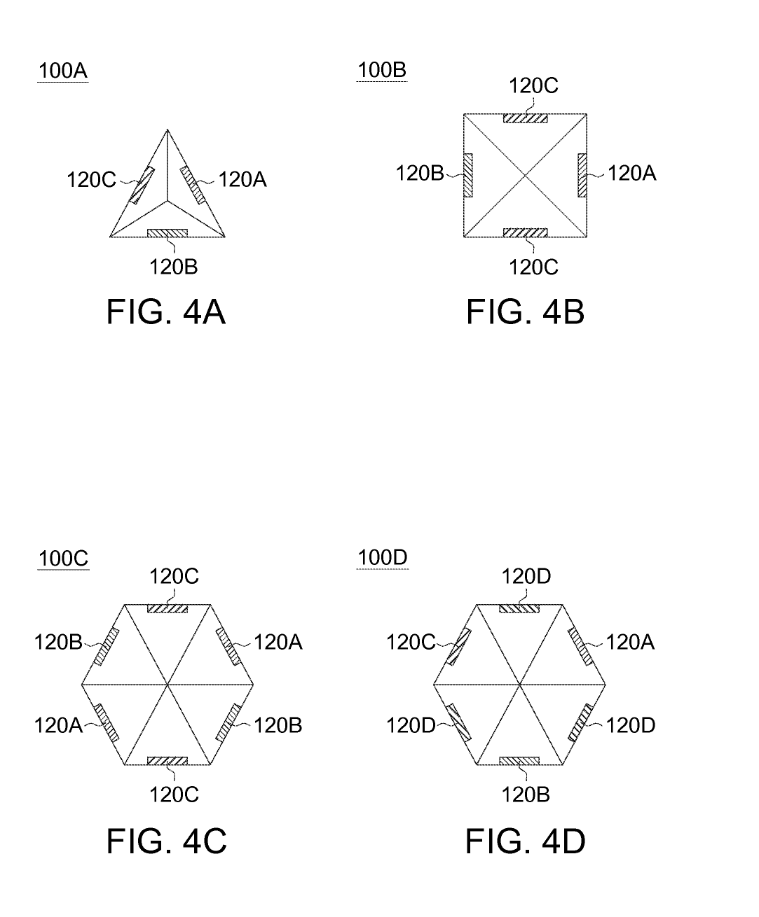

Please refer to FIGS. 1 and 2A˜2C. FIG. 1 is a cross-sectional view of a pixel structure 100 according to an embodiment of the invention. FIGS. 2A˜2C are 3D diagrams of pixel structures 100A˜100C according to different embodiments of the invention. As indicated in FIG. 1, the pixel structure 100 comprises a light emitting surface 110, a plurality of reflectors 111 and a plurality of light emitting elements 120. Each reflector 111 comprises a first reflecting portion 112 and a second reflecting portion 114 connected to the first reflecting portion 112. The light emitting elements 120 are respectively disposed on the first reflecting portions 112 in a direction facing towards the closed light reflecting space C (referring to FIG. 3A). Each of the first reflecting portions 112A˜112C may be a quadrilateral (referring to FIGS. 2A˜2C). Each of the second reflecting portions 114A˜114C may be a triangle (referring to FIGS. 2A˜2C).

The light emitting surface 110 has N sides, wherein N is a nature number (integer) equal to or greater than 3. When the light emitting surface is a triangle, as indicated in FIG. 2A, the light emitting surface 110A is surrounded by three first reflecting portions 112A and three second reflecting portions 114A, and each reflector 111A correspondingly connects with a side S1 of the light emitting surface 110 and is connected to its adjoining reflectors 111A. When the light emitting surface is a quadrilateral, as indicated in FIG. 2B, the light emitting surface 110B is surrounded by four first reflecting portions 112B and four second reflecting portions 114B, and each reflector 111B correspondingly connects with a side S2 of the light emitting surface 110B and is connected to its adjoining reflectors 111B. When the light emitting surface is a hexagon, as indicated in FIG. 2C, the light emitting surface 110C is surrounded by six first reflecting portions 112C and six second reflecting portions 114C, and each reflector 111C correspondingly connects with a side S3 of the light emitting surface 110C and is connected to its adjoining reflectors 111C.

Given that the length of the side is the same, the hexagonal light emitting surface 110C has larger light emitting area than the triangular light emitting surface 110A or the quadrilateral light emitting surface 110B, and the light emitting area of single pixel structure can thus be increased. Besides, in comparison to the design of three light emitting elements 120 respectively disposed on the first reflecting portions 112A, the design of six light emitting elements 120 respectively disposed on the first reflecting portions 112C can at least double the light intensity of single pixel structure so as to increase the light output of single pixel structure.

As indicated in FIG. 1, the light emitting surface 110 has a first normal line L1, the first reflecting portion 112 has a second normal line L2, and the second reflecting portion 114 has a third normal line L3. The second normal line L2 and the first normal line L1 intercross to form an acute angle α between 20˜80 degrees, and the third normal line L3 and the first normal line L1 intercross to form an obtuse angle β between 110˜170 degrees. The light emitting surface 110 and the reflectors 111 define a closed light reflecting space therein C for changing the light outputting direction.

Referring to FIG. 3A, a schematic diagram of a light reflecting space within pixel structure 100 is shown. Each light emitting element 120 faces a closed light reflecting space C defined by the light emitting surface 110 and the reflectors 111 and emits a light B. The lights B are reflected by the second reflecting portions 114 of the reflectors 111 so that the lights B are directed towards the light emitting surface 110.

In addition, the light emitting surface 110 may further comprise a diffuser 130, such as a prism, for refracting or diffusing the lights B to produce a planar light source with uniform brightness. The light emitting elements 120 can be selected from LEDs or organic LEDs of single or multiple colors. The lights B of different colors can be uniformly mixed in each closed light reflecting space C and then the mixed lights are outputted via the light emitting surface 110.

Referring to FIG. 3B, a cross-sectional view of two adjoining pixel structures 100 is shown. A dark region DA is formed between two adjoining pixel structures 100 for separating the first display region VA from the second display region VB. The dark region DA is not a light outputting region, and is formed by two adjoining reflecting portions. The light B emitted from the first display region VA and the light B emitted from the second display region VB will not interfere with each other, so that the display quality of each pixel structure 100 will not be interfered by the stray light nearby.

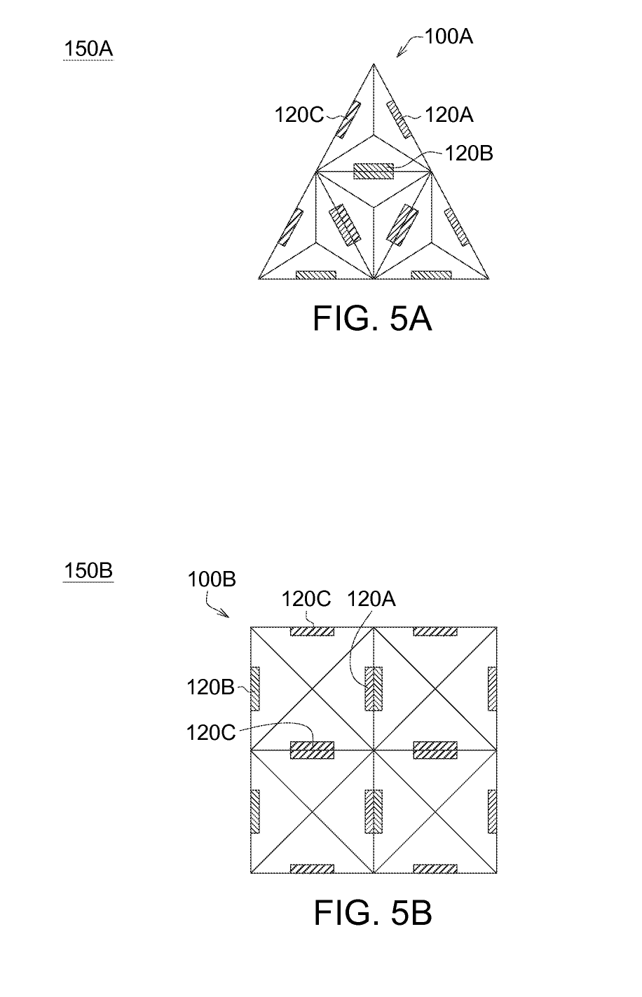

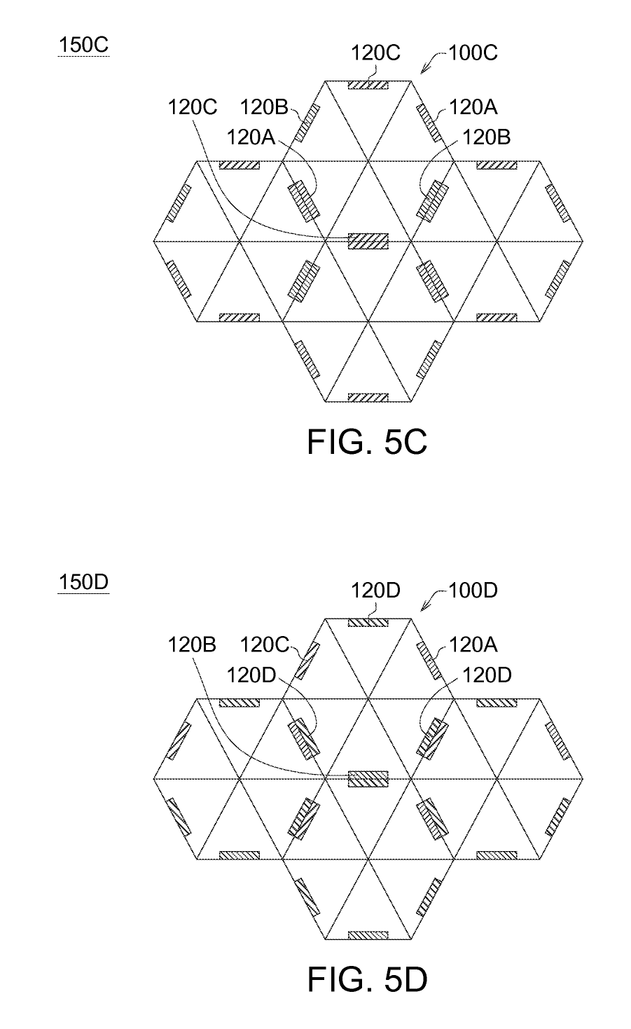

FIGS. 4A˜4D are top views of different pixel structures 100A˜100D. FIGS. 5A˜5D are top views of displays 150A˜150D according to different embodiments of the invention. Each of the displays 150A˜150D comprises a plurality of pixel structures adjoining to each other to form a pixel array. The quantity of pixel structures is exemplified by four in following drawings. However, a large size pixel array can be formed by more than four pixel structures as above arranged in sequence.

As indicated in FIG. 5A, the display 150A is formed by the pixel structures 100A of FIG. 4A. In each pixel structure 100A, three light emitting elements mutually arranging and surrounding the triangular light emitting surface 110A are realized by LEDs of different colors. For instance, the three light emitting elements include a red LED 120A, a green LED 120B and a blue LED 120C. The blue LED 120C is adjoining to the red LED 120A and the green LED 120B respectively. The red LED 120A, the green LED 120B and the blue LED 120C are disposed on peripherals of the pixel structure 100A. The ratio among quantities of the RGB LEDs is 1:1:1.

As indicated in FIG. 5B, the display 150B is formed by the pixel structures 100B of FIG. 4B. In each pixel structure 100B, four light emitting elements mutually arranging and surrounding the quadrilateral light emitting surface 110B are realized by LEDs of different colors. For instance, the four light emitting elements include a red LED 120A, a green LED 120B and two blue LEDs 120C. The two blue LED 120C are adjoining to the red LED 120A and the green LED 120B respectively. The red LED 120A, the green LED 120B and the two blue LEDs 120C are disposed on peripherals of the pixel structure 100B. The ratio among quantities of the RGB LEDs is 1:1:2. In the present embodiment of the invention, the increase in the quantity of the blue LEDs 120C results in an increase in the proportion of blue light in the mixed white light to enhance the energy of the mixed white light.

As indicated in FIG. 5C, the display 150C is formed by the pixel structures 100C of FIG. 4C. In each pixel structure 100C, six light emitting elements mutually arranging and surrounding the hexagonal light emitting surface 110C are realized by LEDs of different colors. For instance, the six light emitting elements include two red LEDs 120A, two green LEDs 120B and two blue LEDs 120C. The two blue LEDs 120C are adjoining to the two red

LEDs 120A and the two green LEDs 120B respectively. The red LEDs 120A, the green LEDs 120B and the blue LEDs 120C are disposed on peripherals of the pixel structure 100B. The ratio among quantities of the RGB LEDs is 1:1:1.

As indicated in FIG. 5D, the display 150D is formed by pixel structures 100D of FIG. 4D, each having a hexagonal light emitting surface. Each pixel structure 100D comprises LEDs of four colors. For instance, the light emitting elements include a red LED 120A, a green LED 120B, a blue LED 120C, and three yellow LEDs 120D. The three yellow LEDs 120D are adjoining to two of the red LED 120A, the blue LED 120C and the green LED 120B. The red LED 120A, the green LED 120B, the blue LED 120C and the yellow LEDs 120D are disposed on peripherals of the pixel structure 100D. The ratio among quantities of the RGBY LEDs is 1:1:1:3. In the present embodiment of the invention, the increase in the quantity of the yellow LEDs 120D results in an increase in the proportion of yellow light in the mixed white light to enhance the brightness of the mixed white light.

In above embodiments, each pixel structure of the displays 150A˜150D, according to the voltage provided by the transistor (not illustrated), controls each light emitting element to emit a color light corresponding to actual image for the displays 150A˜150D to display the image. For instance, when a pixel structure needs to display a blue image, the transistor drives a corresponding light emitting element to emit a blue light; meanwhile, other light emitting elements do not emit the light. When another pixel structure needs to display a red image, the transistor drives a corresponding light emitting element to emit a red light; meanwhile, other light emitting elements do not emit the light. The display using the pixel structures disclosed in above embodiment has the advantages of low power consumption, high color rendering index and high brightness so as to meet the requirements of the market.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel structure, comprising:
an N-side light emitting surface having a first normal line, wherein N is a nature number equal to or greater than 3;
a plurality of reflectors surrounding peripherals of the light emitting surface, wherein each reflector, which correspondingly connects with a side of the light emitting surface, is connected to its adjoining reflectors and comprises a first reflecting portion and a second reflecting portion connected to the first reflecting portion, the first reflecting portion and the second reflecting portion have a second normal line and a third normal line, respectively, the second normal line and the first normal line intercross to form an acute angle α, the third normal line and the first normal line intercross to form an obtuse angle β, and the light emitting surface and the plurality of reflectors define a closed light reflecting space therein; and
a plurality of light emitting elements respectively disposed on the first reflecting portions in a direction facing towards the closed light reflecting space, wherein lights emitted by the plurality of light emitting elements is reflected by the second reflecting portion of the plurality of reflectors so that the lights are directed towards the light emitting surface.

2. The pixel structure according to claim 1, wherein the first reflecting portion is a quadrilateral and the second reflecting portion is a triangle.

3. The pixel structure according to claim 1, further comprising a diffuser disposed on the N-side light emitting surface.

4. The pixel structure according to claim 1, wherein the light emitting elements disposed on the first reflecting portions of two adjoining reflectors are light emitting diodes of different colors.

5. The pixel structure according to claim 4, wherein the plurality of light emitting elements are selected from red, green, and blue (RGB) LEDs.

6. The pixel structure according to claim 5, wherein a ratio among quantities of the plurality of RGB LEDs is 1:1:1 or 1:1:2.

7. The pixel structure according to claim 4, wherein the plurality of light emitting elements are composed of red, green, blue and yellow (RGBY) LEDs.

8. The pixel structure according to claim 7, wherein a ratio among quantities of the plurality of RGBY LEDs is 1:1:1:3.

9. A display, comprising a plurality of pixel structures, wherein the plurality of pixel structures adjoin to each other to form a pixel array, each pixel structure comprising:
an N-side light emitting surface having a first normal line, wherein N is a nature number equal to or greater than 3;
a plurality of reflectors surrounding peripherals of the light emitting surface, wherein each reflector, which correspondingly connects with a side of the light emitting surface, is connected to its adjoining reflectors and comprises a first reflecting portion and a second reflecting portion connected to the first reflecting portion, the first reflecting portion and the second reflecting portion have a second normal line and a third normal line, respectively, the second normal line and the first normal line intercross to form an acute angle α, the third normal line and the first normal line intercross to form an obtuse angle β, and the light emitting surface and the plurality of reflectors define a closed light reflecting space therein; and
a plurality of light emitting elements respectively disposed on the first reflecting portions in a direction facing towards the closed light reflecting space, wherein lights emitted by the plurality of light emitting elements are reflected by the second reflecting portions of the plurality of reflectors so that the lights are directed towards the light emitting surface.

10. The display according to claim 9, wherein the first reflecting portion is a quadrilateral and the second reflecting portion is a triangle.

11. The display according to claim 9, further comprising a diffuser disposed on the N-side light emitting surface.

12. The display according to claim 9, wherein the light emitting elements disposed on the first reflecting portions of two adjoining reflectors are light emitting diodes of different colors.

13. The display according to claim 12, wherein the plurality of light emitting elements are selected from red, green, and blue (RGB) LEDs.

14. The display according to claim 13, wherein a ratio among quantities of RGB LEDs is 1:1:1 or 1:1:2.

15. The display according to claim 12, wherein the plurality of light emitting elements are composed of red, green, blue and yellow (RGBY) LEDs.

16. The display according to claim 15, wherein a ratio among quantities of RGBY LEDs is 1:1:1:3.
